(19) United States
(12) Patent Application Publication
(10) Pub. No.: US 2008/0245860 A1
(43) Pub. Date: Oct. 9, 2008

(54) Method and System for Remote Card Access, Computer Program Product Therefor

(76) Inventor: Marco Polano, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/571,008

(22) PCT Filed: Sep. 9, 2003
(86) PCT No.: PCT/EP2003/009994

§ 371 Date: Mar. 8, 2006

(51) Int. Cl. G06K 5/00

(52) U.S. Cl. 235/382

(57) ABSTRACT

A method for providing an application access to a smart card includes the steps of providing a card reader device for receiving the smart card, providing a computer for running the application, the computer being equipped with a first portion of smart card middleware for interfacing the card reader device, associating with the card reader device a processing unit incorporating a second portion of smart card middleware, and providing a network ensuring communication between the first portion and the second portion of the smart card middleware, thereby permitting access to the smart card by the application.

### FIELD OF THE INVENTION

The present invention relates to techniques enabling access to smart cards (SC). As used herein, the term “smart card” is intended to designate any card device provided with processing capabilities and is thus comprehensive of a number of alternative designations, such as e.g. integrated circuit card, oftentimes resorted to in order to indicate such card devices. Also, the term “smart card” is intended to include arrangements such as those currently designated “USB Tokens” including a smart card in combination with an associated interface such as an USB (Universal Serial Bus) interface.

### DESCRIPTION OF THE RELATED ART

Devices currently used for accessing (e.g. reading) smart cards are connected to a computer via interfaces such as RS232, USB or SCSI serial interfaces. These devices are controlled by the computer to which they are directly connected via specialized software i.e. “middleware”. This enables applications to interact with the smart card inserted in the reader device.

The basic functions carried out by the middleware are:
providing applications with an interface that is independent of the type of reader device and the SC type, by “concealing” from the applications differences in terms of implementation and the related details,
managing the possibility for the applications executed on the computer of sharing SCs and readers, and
providing information on the resources available.

Typically, smart cards are used within the framework of services provided via a communication network. This means that information and applications in the smart card are used by a “client” application executed on the computer terminal to interact with a “server” application being executed on a remote computer.

The client application usually avails itself of the services provided by the middleware in order to interact with the smart card. The middleware in turn avails itself of the services provided by software components (currently referred to as “device drivers”) to communicate with readers directly connected to the terminal via the interfaces.

This scenario is shown in FIG. 1, where reference 10 designates a smart card reader connected via a terminal 12 to a network N. Reference 14 designates a server likewise connected to the network N. Specifically, the terminal 12 is shown to include a client application 21 directly interfacing the network N, a smart card middleware 22 and a device driver 23.

The scenario highlighted in FIG. 1 has intrinsic limitations due to the fact that the readers must be connected directly to the terminal. This makes it impossible for the reader (and the smart card inserted therein) to be shared by a plurality of applications being executed on different terminals. In addition, the number of readers and smart cards adapted to be used simultaneously by a single application is limited. Furthermore, the device driver to be installed on each terminal must be specific for the type of reader used.

An arrangement where a plurality of terminals are adapted to share a reader is disclosed in U.S. Pat. No. 6,247,644. Specifically, this prior art documents discloses a device that permits access to a low-level smart card through a communication network. An intrinsic limitation of the arrangement of U.S. Pat. No. 6,247,644 lies in the criteria adopted for sharing the reader. This prior art arrangement does not permit the reader to be accessed contemporaneously by several terminals/applications.

### OBJECT AND SUMMARY OF THE INVENTION

The need therefore exists of providing an arrangement adapted to permit the intrinsic drawbacks of the prior art considered in the foregoing to be overcome.

Specifically, the need is felt of arrangement where, i.a.:
one or more readers (and the smart cards inserted therein) can be shared by a plurality of applications being executed on different terminals, while also expanding the number of readers and smart cards adapted to be used simultaneously by a single application;
the device driver to be installed on each terminal is no longer specific for the type of reader used, and
the possibility exists of identifying the readers, the smart card and other resources possibly available.

According to the present invention, that object is achieved by means of a method having the features set forth in the claims that follow. The invention also relates to corresponding system as well as a corresponding computer program product loadable in the memory of at least one computer and including software code portions for performing the method of invention. Reference to “at least one computer” is evidently intended to highlight the possibility of implementing the invention in a distributed arrangement.

The arrangement described herein overcomes the intrinsic limitation of the prior art permitting access to a reader device by the application via a network such as e.g. network based on an IP protocol. In that case, the network comes into play in permitting communication between the middleware residing on the terminal and the smart card reader. The middleware may thus be adapted in such a way that any event concerning management of a specific type of smart card remains on the terminal while all events and information related to management of a specific reader is allotted to a remote device provided with a reader.

It will thus be appreciated that, in such an improved arrangement, networking technologies, with respect to the connection between application and smart card, are used at different level with respect to the prior art. In fact, in the arrangements of the prior art the network comes into play at the application level, while in the arrangement described herein the network comes into play at the middleware level. A network is a combination of connections linking two or more separate devices enabling to selectively establish communication between each two of the devices.

Typically, the application level will communicate via a geographic network (for instance the Internet), while the middleware level will communicate via a local network. The possibility is also envisaged that the middleware level may be adapted to communicate via internet. In the case of a pair of computers equipped with operating systems including the same type of middleware, the arrangement described herein may be used in order to permit applications running on either computer to use both those readers that may be installed locally and those readers possibly available remotely.

This will occur exactly in the same manner, without any changes being required in the applications. Stated otherwise, such a preferred embodiment of the invention makes all the services at the middleware level available to all the elements in the system.

In addition to providing the possibility of sharing a smart card and an associated reader, the arrangement disclosed also solves problems related to searching and identifying available resources. In fact, the middleware services enable applications and users to recognize, identify and search automatically and/or in an assistant manner the system resources.

In brief, the arrangement described herein provides (especially in comparison with the prior art arrangement disclosed in U.S. Pat. No. 6,247,644) the following advantages:
a flexible sharing of the resources permitting a simultaneous access by several applications,
automatic and/or assisted identification of the system resources, and
the possibility for applications to use both local and remote readers in exactly the same manner without any modifications being required in the code.

### BRIEF DESCRIPTION OF THE DRAWINGS

The invention will now be described, by way of example only, with reference to the annexed figures of drawing, wherein:

FIG. 1, representative of a typical prior art arrangement, has been already described in the foregoing,

FIG. 2 portrays, by way of direct comparison with FIG. 1, a typical embodiment of the arrangement disclosed herein,

FIG. 3 is another functional block diagram detailing the arrangement disclosed herein,

FIG. 4 shows a modified embodiment of the arrangement disclosed herein, and

FIG. 5 shows a typical example of RPC communication within the framework of the arrangement described herein.

### DETAILED DESCRIPTION OF EMBODIMENTS OF THE INVENTION

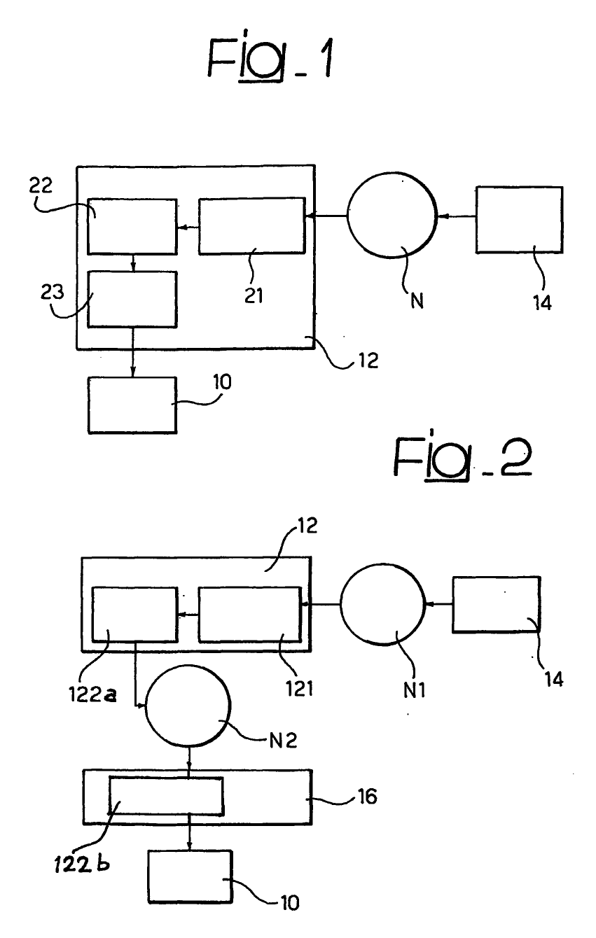

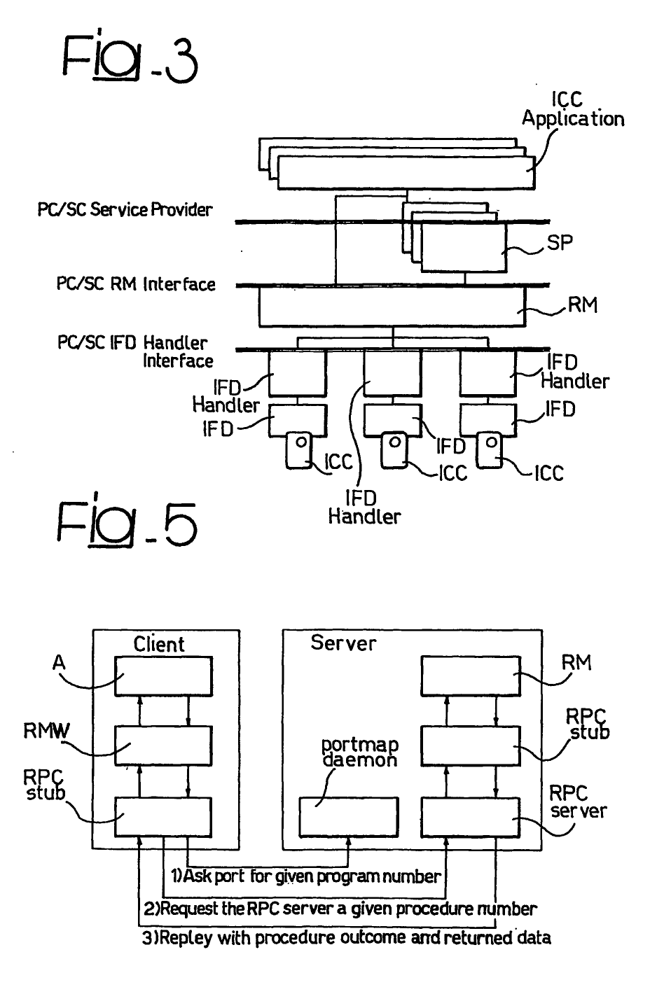

FIG. 2, the same reference numerals have been used to designate parts/components/functions that are identical or equivalent to those already described in connection with FIG. 1.

It will thus appreciated that in the arrangement of FIG. 2, the terminal 12 can be seen as comprising the client application 121 and a first portion 122a of the smart card middleware, while interaction with the smart card reader 10 is managed by means of a computer (or an equivalent processing unit) 16, comprising a second portion 122b of the smart card middleware, connected to the terminal 12 via a local network N2.

Communication between the server 14 and the terminal 12 takes place via a “geographic” network N1 which can be essentially as the equivalent of the network designated N in the block diagram of FIG. 1.

As indicated in the introductory portion of this description, the term “smart card” is used herein to indicate any kind of card device provided with the processing ability. More detailed information on these cards can be derived from ISO/IEC specifications (where they are designated “identification cards”) and more specifically from the specifications listed in the following:

ISO/IEC 7816-1, Identification cards—Integrated circuit(s) cards with contacts Part 1: Physical characteristics.

ISO/IEC 7816-2, Identification cards—Integrated circuit(s) cards with contacts Part 2: Dimensions and location of the contacts.

ISO/IEC 7816-3, Identification cards—Integrated circuit(s) cards with contacts Part 3: Electronic signals and transmission protocols.

ISO/IEC 7816-4:1995, Identification cards—Integrated circuit(s) cards with contacts Part 4: Interindustry commands for interchange.

ISO/IEC 7816-4:1995/AM1:1997, Identification cards—Integrated circuit(s) cards with contacts Part 4: Interindustry commands for interchange—Amendment 1: Impact of secure messaging on APDU structures.

The arrangement disclosed herein enables a terminal acting as a client and provided with a network connection to access a smart card reader 10 installed (or integrated) in a second device 16 which is connected to the same network. The second device 16 acts in the network as a server. The term “server”, although applicable in general to any device acting as a server with respect to the client application running on terminal 12, will be used in the following of the description mainly to refer to a device, such as device 16 in the embodiment of FIG. 2, that integrates, or is directly linked with, a smart card reader (such as smart card reader 10 in FIG. 2).

For example a personal digital assistant (PDA) (12 in FIG. 2) equipped with a wireless LAN interface (e.g. implementing the standard IEEE 802.11), can access a smart card inserted in a reader (10 in FIG. 2) which is connected to a personal computer (16 in FIG. 2), provided that both the PDA and the personal computer are connected to the same IP network (e.g. the network N2 in FIG. 2).

This architecture offers some other complementary functions.

Many servers and clients can coexist on the same network within the framework of a “many to many” relationship (i.e. a client communicates with many servers and a server communicates with many clients).

Also, clients can automatically discover servers connected to the network, and clients can automatically identify servers with unique names even if servers change their IP address. A plurality of clients can share the same smart card reader. Servers can apply security policies to prevent unauthorized access to the smart card reader.

These functions are significant both in order to simplify the application and in order to enable complex scenarios were many clients access many servers.

In certain applications many devices use the same smart card in the same reader. In that way, e.g. different personal computers may have access to the same smart card to digitally sign documents with the same signature (e.g. in a legal or purchase department).

Most small devices such as PDAs cannot be connected to external smart card readers just because they are not equipped with a suitable interface. However many of them have some kind of network interface that permit access to an IP network. This same physical interface could be used to connect the device to two logical networks, a local network N2, for accessing to an external reader, and a geographic network N1.

In some applications it is useful to render the same smart card available to a plurality of devices for authentication purposes. A service provider may in fact store authentication information in the same smart card for different purposes.

Some examples are: access to services from a PC via some web-based application, access to a local wireless LAN, and establishment of virtual private network (VPN) connections. In this case, different devices need to access different pieces of information in the same smart card.

In still other applications (e.g. in hotels), access to rooms is controlled by smart cards. In that case, each access control point may be provided with a special smart card reader connected to a LAN. Within the same LAN one or more personal computer may act as central control points were security personnel could control the list of enabled smart cards and have access to data and statistics.

Those examples dictate certain preferred requirements for the server and the client.

Both the server and the client are provided with a network interface and are able to process IP packets according to the TCP/IP suite of protocols (i.e. UDP, ICMP, ARP, etc.). Also, the server shall be provided with at least one smart card reader.

When those requirements are met, the software running on the client and the server units can be considered as a distributed application adapted to be implemented using standard remote procedure protocols such as ONC-RPC, XML-RPC, CORBA, DCOM, SOAP.

The various acronyms reported in the foregoing are well known to those of skill in the art, thus making it unnecessary to positively indicate what these acronyms stand for.

Assuming that a request-reply communication model is implemented, the services that may be requested from the clients to a server may be the following:
defining a context for all operations: this context allows the server to distinguish the client requests and to manage its internal resources;
performing tracking operations on the server's reader: these tracking operations shall be used for example to detect if a smart card is present, what kind of smart card is inserted in the slot at the moment; whether the status of the reader has changed since the last access, etc;
accessing a smart card in the server's reader;
resetting the status of the server's reader and/or the smart card; and
detecting servers on the local LAN.

In addition to these services, the server can implement additional functions to protect the smart card reader from unauthorized access. This is preferably achieved by controlling the origin of each request. The controlling entity in the server shall permit the requested operation only if the originating client identity is in a list of enabled network nodes. If otherwise, the request is discarded.

A preferred goal of the arrangement shown herein is to avoid modification of existing applications. The interface between clients and servers is thus “wrapped” in a software module to present to the application a standard software interface. The wrapping module implements all the services of the standard interface. It also hides all the internal details about the communication of the client and the server, and preserves the accessibility to the smart card subsystem running on the client system.

In that way, the wrapper allows applications running on a client device to access both the local connected readers and the remote readers (those connected to servers), without the applications becoming aware of any differences between them.

In the arrangement shown herein the following assumptions were made:
the server implements at least a portion 122b of the personal computer smart card (PC/SC) middleware;
the applications running on a client unit are based on PC/SC;
the ONC-RPC (Open Network Computing—Remote Procedure Call) protocol is used for client-server communication.

It will be appreciated that those assumptions do in no way represent mandatory requirements. The solution described herein is thus still fully operable even when changing these assumptions, as long as the communication is based on a remote procedure call concept.

In the following a description will be provided of how the concepts mentioned in the foregoing may be integrated into a PC/SC architecture.

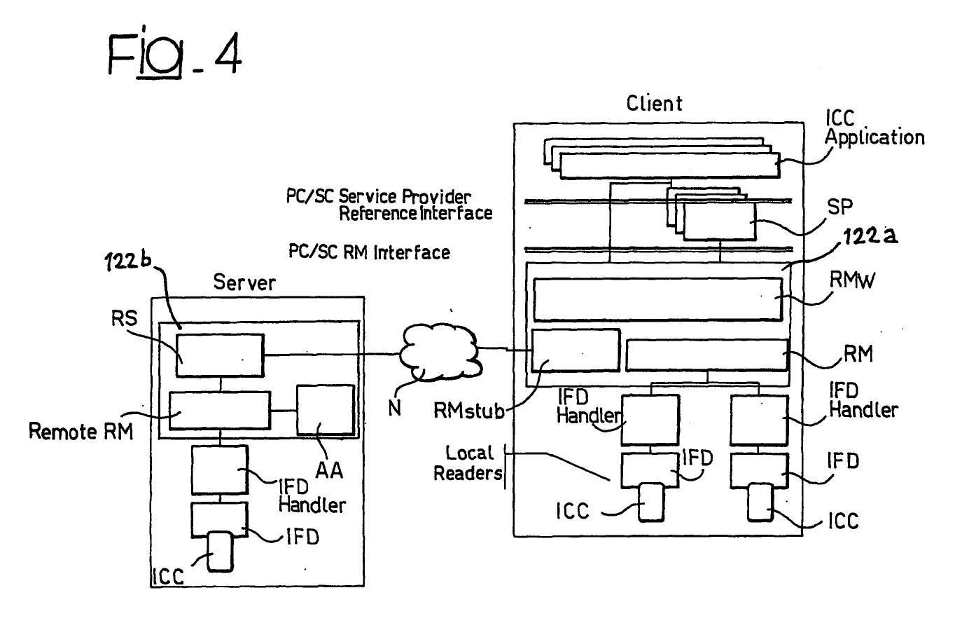

The components specified by a PC/SC (Personal Computer Smart Card) standard architecture (as depicted in FIG. 3) are:
the integrated circuit cards (ICC): this is the term used in the PC/SC specification for the smart card component, this specification being intended to be applicable to any ICC which complies with ISO/IEC 7816.
the interface device (IFDs): these components are commonly called “smart card readers” and represent the physical interface through which each ICC communicates with the server device;
the interface device handlers (IFD Handlers): the IFD Handlers are the modules necessary to map the capabilities of the smart card reader into the PC/SC defined application programming interface (API). These modules are generally low-level components that take care of the control of the electrical interface with the IFD. In the solution described herein, the IFDs are integrated with the server device (or connected to it) and the IFD Handlers are installed on the server itself. The clients are not required to be aware of the existence of this component;
the ICC resource manager (RM): this is the central component of the PC/SC architecture. It is responsible for tracking resources, controlling the allocation of IFDs to applications and controlling the integrity of accesses to ICCs. In a modified architecture according to the invention (to be described in the following in connection with FIG. 4), both the server module and the client module include a resource manager component to manage both the local and the remote ICC resources (see below);
the service provider (SP): the service provider is responsible for encapsulating the ICC functionality and exposing an high level interface to applications. Here it is assumed that the service provider is implemented in the client.

The PC/SC service providers rely on the services provided by the resource manager (RM) to offer a high level interface to the smart card applications. For that reason they are strictly dependent on the applications and are installed on client devices. All applications running on clients usually do not rely on service providers installed on the server (which may be used by local applications).

One of the main criteria adopted in the invention architecture described herein is to maintain the independence of the server from the applications. This means that the server does not require modifications to support applications. This requirement also implies that the server is independent of the ICC type, at least insofar as the ICC is compatible with the IFD.

Since the resource manager RM is the component responsible for allocating the IFD to applications, and it does not depend either on the ICC or on the applications, it can be “split” between the client and the server devices. Specifically, all the functions that control the use of resources are implemented in the server, while all the resource queries and a part of the tracking functions are implemented in the clients.

Since the communication between the service providers SP and the resource manager RM is specified in terms of an application programming interface (API), it is simple to map the API functions onto a set of remote procedure calls.

Some restrictions and some extensions are however to be taken into account:
i) operations with timeout are managed by the client and not by the resource manager on the server (as is the case in a standard PC/SC architecture). In fact a client may require an operation involving more than one server at the same time, and the timeout can only be detected by the client;
ii) autodetection of servers requires some additional procedures on the server not specified in the original PC/SC specifications;
iii) in order to improve communication efficiency the flexibility of the, PC/SC resource manager interface is somewhat reduced;
iv) some resource query services that are normally provided by the resource manager are provided by the client to maintain independence of the server from the applications and the ICCs; and
v) a client that connects to more than one server is actually connecting to many different resource managers. This is a significant difference from the principles of the original PC/SC specifications where the overall system has only one resource manager.

To ensure compatibility with existing PC/SC-based applications, the original PC/SC architecture can be modified as shown in FIG. 4.

In FIG. 4 the same references have been used to indicate parts and components that are identical or equivalent to those already described in connection with FIG. 3.

Essentially, in the arrangement of FIG. 4, two new components have been added on the client, namely:
a resource manager stub (RM Stub), and
a resource manager wrapper (RMW).

The RM Stub hides the details related to the communication over an IP network and presents to the wrapper component RMW an interface that is very similar to the one provided by the PC/SC resource manager, but with the above-mentioned restrictions and extensions.

The wrapper RMW is responsible for the management of the communication with many different servers and with the local resource manager. In fact the architecture allows applications running on clients to access both local and remote IFDs. The local IFDs are accessed through the local resource manager in accordance to the PC/SC specifications, the remote IFDs are accessed through the remote resource managers running on the servers.

At the client side the first portion 122a of the smart card middleware thus comprises the RM Stub, the wrapper RMW and the resource manager RM. At the server side, the second portion 122b of the smart card middleware comprises another resource manager Stub RS and a remote resource manager (remote RM).

As already mentioned, the remote resource manager RM in the server does not necessarily implement all the functions required by the PC/SC specifications. Since only clients need to be aware of the ICC types and the related service providers, all those services related to the smart card type identification and listing may not be implemented at all (unless needed by applications running on the server itself).

In order to be compliant with PC/SC specifications the resource manager interface should provide certain functions that are grouped in six functional categories, namely:
Smart Card Database Query Functions,
Smart Card Database Management Functions,
Resource Manager Context Functions,
Smart Card Tracking Functions,
Smart Card and Reader Access Functions, and
Direct Card Access Functions.

Database query functions provide the applications with facilities to classify smart cards with their associated service providers and to classify and identify readers. Classification of smart card and service providers are implemented at the client side because the server should not preferably depend on particular smart cards and service providers. Classification and identification of readers must also be implemented at the client side since only the clients can have a global view of the readers that are available to them. Moreover, these functions are used to give helpful names to readers to assist the users to select them. Each user should be able to choose the name that he/she would like to assign to the readers. This again may require that the database reader identification services is implemented in the client.

Programs that install new components use database management functions to update information in the resource manager database. For this reason also these functions are implemented at the client side.

The server could also implement database services for local running applications, but usually these functions are not used by the clients or are accessible via remote procedure calls.

Generally, the direct card access functions are not implemented. In fact, these functions are used only by applications that desire control of the IFD at a very low level.

An application which is remotely accessing a smart card normally does not know the details of the IFD. For this reason, even if a direct access function would be implemented, it is unlikely that the applications may have direct access to the remote smart card reader: in fact this function was introduced in the PC/SC standard to allow access to devices not compliant to ISO-7816

All the other functional groups, i.e. context functions, tracking functions and reader access functions, are implemented at the server side and are available as remote procedure calls.

In addition to the elements previously discussed, the architecture shown in FIG. 4 includes an access module in the server.

This module is designated as access and authentication module (AA).

Since the server is connected to a network N, any device running the client software could use the server's IFDs. This could introduce some security concerns if no action is taken to prevent unauthorized use of the smart card inserted in the IFD slots.

The access module AA has the responsibility of determining if every single access to the IFD and/or the ICC is allowed. In general, the access module could be based on two lists of rules and a default behaviour: the first list of rules is used to explicitly allow the usage of the IFD and/or the ICC, the second one to explicitly deny it. The default access rule should be applied whenever an access does not match either of the two lists.

For instance, only one permission list could be used with just one kind of rule. The server stub, designated RS in FIG. 4, before calling a resource manager function, checks if the MAC-level address of the device originating the RPC call matches with one of the MAC addresses in a list.

In the following, a more detailed functional description of the wrapper and stub functions will be provided.

For further information and additional details on specific PC/SC issues reference can be made to the PC/SC specification PC/SC Revision 1.0 1997 (all parts), Interoperability specification for ICCs and personal computer systems (http://www.pcscworkgroup.com) and to the Microsoft documentation Microsoft MSDN library: Introduction to the Windows Smart Card subsystem and Microsoft MSDN library: Smart Card Resource Manager API.

In a normal procedure call, a calling process executes the procedure in its own address space. In a remote procedure call, the calling process and the called procedure can run on different machines. The calling process in this case can be considered a client application, requesting some service from a server. The two processes communicate through “stubs”, one each for the server and the client. The stubs are pieces of code that contain the functions to map the local calls into a series of function calls that take care of the network communication details.

In a preferred implementation, the ONC-RPC network protocol has been chosen as this is available for a large number of different platforms and operating systems. In addition ONC-RPC libraries have a very small memory footprint that is very suitable for memory-constrained devices. In the ONC-RPC protocol the calling process issues a request that is transferred through the network to the called process. The called process executes the indicated procedure and, if necessary, replies by returning the required information.

Client and server modules are able to communicate using a machine independent data representation. This is important when the server and the client are running on devices with different internal data representation format. To this purpose ONC-RPC uses the single-canonical representation format, known as external data representation (XDR). Any data included with a request/reply from/to the calling process is translated in and out the XDR format by the stubs using the XDR library.

For each RPC request two C structures are defined: one including all the input data and another one including all the output data.

For each RPC request the following steps are performed:
the stub at the client side arranges all input data into an input structure;
the input structure is passed to the library routines for conversion to the XDR format;
a call to the RPC function is performed to communicate the request and the input data to the server;
the server receives the RPC request, converts the XDR formatted data into the internal machine dependant format and calls the server stub function;
the stub function uses the input data to call the appropriate resource manager method. The output of the method call is then written into the output structure and returned to the RPC server process;
the RPC server process converts the output structure and all the additional information regarding the outcome of the requested operation into the XDR format;
a reply message is generated and sent back to the client;
the client verifies if the RPC call was successful (e.g. if a timeout occurred) and returns the output data to the calling process.

Different RPC services may coexist on the same server; each service is thus identified with a unique program number. A process belonging to the operating system, called portmap, converts the program number into UDP or TCP port numbers. Portmap must be running on the server machine in order to make RPC calls.

When a remote port call (RPC) server is started, it will tell portmap what port number it is listening to, and what RPC program numbers it is prepared to serve. When a client wishes to make an RPC call to a given program number, it will first contact the portmap on the server machine to determine the port number where RPC packets should be sent. Then the client will contact the RPC server to make a call to a given procedure number.

This process is further detailed in FIG. 5.

The resource manager stub component at the server side is stateless and simply performs the requested action by calling some of the resource manager functions in the appropriate sequence.

To control communication with each server, the stub (RPC Stub) at the client side maintains a status with each open channel. For this purposes the following information is kept for each known IFD (i.e. smart card reader):

Server Name

The server name is used to address it on the IP network. This information can also be replaced by the IP address.

IFD Remote Name

Servers can have more than one IFD. In this case each IFD is identified by the server itself with a name that is unique only in its context. This name cannot be used to identify the IFD on the client.

Server Unique Identifier

If the server is addressed by its IP address instead of its name (i.e. a DNS is not available) this information identifies the server even if it changes the IP address. This identifier for Ethernet networks is the MAC address of the server.

RPC Communication State

Before a RPC call a client must open a communication channel with the server. This is the status information of the channel.

Number of Open Contexts

The communication channel is opened only when an application on the client establishes the first context. On the contrary the channel is closed when all contexts are released. When the stub releases a contexts on a given server, it needs to know how many contexts are still open to know whether the communication channel may be released or not.

When the smart card subsystem starts-up, the client stub is initialised and a first list of remote readers (IFDS) is created starting from a configuration file. Then an RPC broadcast call is performed to detect new servers. All servers receiving the broadcast RPC call should reply with the information regarding all the IFDs they are controlling. The stub analyses each reply in steps:
as a first step, it searches the unique server identifier of the replying server within the list of the already known IFDs;
then, if the unique identifier is not found (which means that a new server has been added to the network) the stub then uses the IFD information in the server reply to add those IFDs to the list;
conversely, if the unique identifier is found, the stub compares IFD information supplied by the server with that contained in its list and, if needed, updates it.

After a predefined period of time the client stub assumes that all replies have been received and that the information in the IFD list is updated. If the list has been modified, the configuration file is also updated.

The reader identity in the client stub can be stored in a C structure (designated REMOTEREADER) chosen to identify the readers by a pointer to their structure. Each time the wrapper calls a stub function to request an operation for a specific reader, it has to specify it providing a pointer to the appropriate structure.

The resource manager wrapper RMW is the component that in the clients provides applications with an API that complies with the PC/SC standard. This component uses the services provided by lower level components to perform the operations that the applications request. In the general case, the wrapper relies on the RPC stub component for accessing servers on the network and on the local resource manager for accessing local resources (smart card and readers). The wrapper is also able to provide some database services by merging database information coming from the local resource manager with that it is providing by itself. This scheme ensures that even in the case the local resource manager does not exist, applications can still work because the wrapper provides the full set of resource manager services.

When the smart card sub-system starts-up, the wrapper initialises its internal data structures and calls the stub initialisation routine to perform server detection. Because one of the wrapper functions is to track the IFDs in the system, it needs to keep the information regarding the state of each one of them. The information in the stub and in the wrapper will thus have to be consistent.

To match the information that the wrapper and the stub maintain, the stub initialisation routine returns to the wrapper a list of pointers to its internal structures. The stub will use these pointers internally to access the REMOTEREADER structures and retrieve the information concerning the communication status, the server IP address and the reader name (as known by the server). The wrapper compares this information against the configuration file to complete its reader information structures and to determine if new readers have been connected to the system. In the case the wrapper detects a new reader it should alert the user that a new, previously unknown IFD, has been added and may request him to provide a meaningful name for it. The name supplied by the user is than used for any further call to the wrapper to reference the IFD.

For each reader the wrapper keeps the status of its server. If at any point in time a server does not reply to the RPC call, the stub returns an error to the wrapper. The wrapper then assumes that the server went offline and reset its state in its internal data structures (i.e. for every existing context map the contexts handles of that server are reset and all the card handles maps referring to it are removed).

Reader detection is not only performed at start-up. At specific times the wrapper calls the stub functions that perform server detection (as previously described for the stub initialisation). In this case, the stub updates its internal information on servers and IFDs and if any change occurred, it reports this to the wrapper.

In the following the functions of the wrapper for the six functional categories previously indicated will be described.

Specifically, in the exemplary embodiment described herein it has been assumed that a local resource manager RM exists in the client, even if no local readers have been installed. This assumption allows the wrapper RMW to rely on the local resource manager to perform the database functions by redirecting the queries and management functions to it. If the client does not have a local resource manager, the wrapper will not be able to provide to applications all the PC/SC standard services.

Even if the local resource manager performs most database functions, the wrapper should preferably at least manage the queries and the management operations that involve the remote readers. In fact the local resource manager cannot manage them since they are completely unknown to it.

When an application performs a database query with functions ListReaderGroups or ListReaders (see, in that respect the PC/SC specifications cited in the introductory portion of this description) the wrapper will call the equivalent functions of the local resource manager. The results will then be merged with the wrapper internal information and returned to the application without any RPC call.

All the remaining database functions (that involve smart card types and service providers) will be completely managed by the local resource manager.

The context functions are used to establish and release a resource manager communication channel between the resource managers and the applications (or the service providers). In PC/SC terminology this channel is called context. An application establishes a channel with a call to the function EstablishContext. This function returns a context handle that is used by the application with any further call to the resource manager to identify the opened channel.

In the arrangement described herein, many different resource managers are involved and a context with each of them should be established before any communication can take place. For this reason, the wrapper RMW establishes a context with each resource manager any time an application asks for a new context. In the same way, the wrapper releases the context with each resource manager each time an application close a context.

Each time a context is established, the wrapper RMW creates a map were the context handles returned by each resource manager are associated to an internally generated handle that is returned to the application. This internally generated value is called virtual context.

The map (which is preferably constituted by a C structure designated CONTEXTMAP) is used to translate the virtual context supplied by applications into the specific context handle recognized by each resource manager.

When the function responsible for context release (ReleaseContext in the PC/SC specifications) is called, the map is deleted.

The CONTEXTMAP structure has one member to store the virtual context handle generated by the wrapper itself, a second member to store the context handle used by the local resource manager and a third member which is an array of context handles returned by the remote resource managers.

The PC/SC specifications provide for two main functions being offered for the smart card tracking purposes.

The former ensures that the calling application is made aware of all changes across a set of readers of interest. This service is provided by the function designated GetStatusChange. The GetStatusChange function blocks execution until, the current availability of the cards in a specific set of readers changes.

The latter function enables applications to search in a given list of readers for a specific smart card by using the function designated LocateCard.

Both for the GetStatusChange and the LocateCard functions, the caller supplies a list of readers to be monitored by an array designated SCARD_READERSTATE.

Applications allot the function GetStatusChange with a maximum amount of time that they are willing to wait for an action to occur. This function uses the application-supplied value in the dwCurrentState members of the SCARD_READERSTATE array as the definition of the current state of the readers as seen by applications. The function returns when there is a change in availability, having filled in the dwEventState members appropriately. The dwEventState members indicates if the status of a particular reader has changed, and in such case what is the change (e.g. another application started to use that reader or a smart card has been removed from the reader's slot).

When an application calls the GetStatusChange function, the wrapper starts a polling loop on all the resource managers (both the local and the remotes). At each loop the GetStatusChange function of one specific resource manager (remote or local) is called with a zero timeout and the elapsed time since the starting of the loop is checked to be lower than the timeout value.

The loop is stopped only if one of three events occurs, namely:
the elapsed time is greater than the timeout value provided by the application;
a resource manager reports a status change on one of its readers; and
one of the available remote resource manager is no longer reachable

The third event could occur for example if the server was powered off or if the network connection was interrupted. This event causes the readers accessed through that server to become unavailable and must be reported to the application as a change of state from available to unavailable.

When an application calls the LocateCard function it provides a list of smart card names to look for, together with the list of readers. The function searches the readers for a card with an answer-to-reset (ATR) string that matches one of the card names specified, returning immediately with the result. The first action that the LocateCards must perform is to query the resource manager database to retrieve the ATR string for each of the smart card names in the list. Then it should call the LocateCards function of each specific resource manager involved (i.e. that controls at least one of the readers in the list).

In addition to the LocateCards and GetStatusChange function a Cancel function is also available. Its purpose is to block a pending GetStatusChange operation.

The smart card and reader access functions are adapted for managing the connections, controlling transactions, sending and receiving commands, and determining card state information.

The command interfaces are designed to simplify interaction with a card using the protocols ISO/IEC T=0 and T=1. A “raw” mode is additionally supported by the PC/SC specifications to support arbitrary data exchange protocols (such as T=14) for special-purpose requirements. Since the arrangement described herein is intended to support only T=0 and T=1 protocols, the PC/SC “raw” mode and its related functions are not supported.

Before exchanging data with the smart card an application calls the Connect function to open a channel. The Connect function returns to the calling application a handle (called card handle) that must be supplied to any function that addresses the connection that has been established. At the end of the data exchange the applications calls the Disconnect function to explicitly close the channel.

When a call is placed to the Connect function, the wrapper receives the name of the reader were the smart card to connect is inserted. The wrapper RMW retrieves the information about the reader by matching the name against those he has in its internal structures. If none of the known readers matches the supplied name, a call is done to the local resource manager. On the contrary, if a reader with the correct name is found and its state is set to online, a Connect request is sent to the associated server.

If the connect function called by the wrapper is successful, a card handle is returned. The wrapper then generates a virtual card handle value and stores the mapping between it and the card handle value received from the invoked resource manager. This mapping is necessary to avoid conflicts in the case two resource managers return the same card handle value.

The mapping between virtual card handles and real ones is done with a structure designated HANDLEMAP. This structure also stores the information necessary to correctly address the server and the reader in the system, e.g.:
the virtual context value;
a flag to indicate if the connection is going through a remote resource manager or the local one; and
a reference to the context in the remote resource manager (RM) and to the server identity.

When an application disconnects a card handle, the wrapper removes the corresponding card handle map and a call to the Disconnect function of the appropriate resource manager is performed.

The other smart card access functions do not require special actions from the wrapper RMW. In those cases the card handle provided by the application is used to identify the associated server and the correct IFD. Then a request for the procedure corresponding to the required operation is sent to the server. The data contained in the reply from the server is simply returned to the application.

Applications are not concerned about the communication method used to access the IFDs and, as a consequence, they do not know what to do if an error originating from RPC functions is returned.

In fact, applications relying on PC/SC are designed to handle only standardised error types that convey information about problems associated with smart card or readers. For this reason RPC errors are restricted in the stub components. The types of errors that originate from the RPC communication are not handled by the wrapper. However, the stub returns to the wrapper only the information that some communication error occurred. This information is used to determine if the state of the server involved should be set to offline.

If some communication error occurs the user may be informed of the source of the problem in order to permit a correction action.

The stub should filter the RPC errors and notify to the user only the most critical ones with meaningful messages. The way this notification is implemented largely depends on the type of client device. For example in the case of a PC it could be a dialog box, in the case of an embedded device that is not equipped with a display (such as an ADSL router) it could be a line in a diagnostic log.

The error handling in the wrapper and in the stub takes into account that in some situations many errors coming from different sources may occur in a function before returning control to the caller. In these cases a decision is taken regarding the operation outcome that have to be returned.

This kind of situation comes about when the wrapper needs to call a function on more than one resource manager to accomplish some operation. In these cases the wrapper returns an error only if the set of problems that have been encountered prevents the application any further operation on the resources involved.

For instance, when a context has to be established, the wrapper places an EstablishContext function call for each resource manager. If some resource managers cannot establish the context but some other do, the wrapper returns a successful outcome to the application and, in the context map, it keeps track of which resource managers did not established the context. If the errors returned by some of the calls to the stub were caused by RPC communication problems, the involved servers are set offline. If, during the lifespan of the context, these servers come online, the wrapper attempts to connect them to it. This is done to maximize at any given time the number of resources that the applications can access.

Of course, the underlying principles of the invention remaining the same, the details and embodiments may vary, also significantly, with respect to what has been described and shown, by way of example only, without departing from the scope of the invention as defined by the annexed claims.

1. A method for providing at least one application with access to at least one smart card (SC), the method including the steps of:
providing at least one card reader device (10) for receiving said smart card, and
providing at least one computer (12) for running said at least one application (121), characterized in that it includes the steps of:
providing said at least one computer (12) with a first portion (122a) of a smart card middleware,
associating with said card reader device (10) a processing unit (16) running a second portion (122b) of a smart card middleware, and
ensuring, by means of a network (N2), communication between said first (122a) and second (122b) portion of smart card middleware, thereby permitting access to said at least one smart card (10) by said at least one application (121).

2. The method of claim 1, for providing said at least one application with access to one of a plurality of a smart card types, characterized in that it includes the step of incorporating with the said first portion of smart card middleware (122a) information concerning said plurality of types of smart cards.

3. The method of claim 1, characterized in that it includes the step of associating with said processing unit (16) information specific to managing said card reader device (10).

4. The method of claim 1, characterized in that it includes the step of providing said network (N2) in the form of a local network.

5. The method of claim 1, characterized in that it includes the step of providing said network (N2) in the form of a geographic network such as the Internet.

6. The method of claim 1, characterized in that it includes the step of running concurrently at least one pair of said applications (121) and providing said at least one pair of applications (121) with access to said at least one smart card (10) via said card reader device (10) interfaced with respective first (122a) and second (122b) portion of smart card middleware via said network (N2) and said processing unit (16).

7. The method of claim 6, characterized in that it includes the step of running said at least one pair of applications (121) on different computers.

8. The method of claim 1, characterized in that it includes the steps of:
providing at least one pair of computers (12) each running at least one respective application (121),
providing at least one card reader device (10) having associated said processing unit (16), and
connecting said at least one pair of computers (12) to said at least one card reader device (10) via said network (N2).

9. The method of claim 1, characterized in that it includes the steps of:
providing at least one pair of card reader devices (10) having associated respective processing units (16), and
connecting said at least one pair of card reader devices (10) to said network (N2) whereby said at least one application (121) is adapted to access respective smart cards (10) received in any of said at least one pair of card reader devices (10) in a substantially identical manner.

10. The method of claim 9, characterized in that it includes the step of arranging said card reader devices of said at least one pair of card reader devices (10) at different geographic locations.

11. The method of claim 1, characterized in that it includes the step of incorporating to said first portion (122a) of said smart card middleware information concerning available system resources, whereby said at least one application is adapted to identify said system resources via said first portion (122a) of said smart card middleware.

12. The method of claim 1, characterized in that it includes the step of generating a system architecture including:
a base layer including said at least one card reader device (ICC; IFD) as well as a respective interface handler (IFD Handler) formatting the capabilities of said card reader device in a defined application programming interface (API),
an intermediate layer (RM) providing a resource manager (RM) capability for managing resources of said at least smart card interfacing with said first level, and
a service provider layer (SP) for encapsulating the functionality of said at least one smart card (10) and exposing a high level interface to said at least one application (121).

13. The method of claim 12, characterized in that it includes the step of defining within the framework of said architecture:
at least one client module including said first portion (122a) of smart card middleware comprising said base layer (ICC, IFD, IFD Handler) and said intermediate layer (RM), and including said service provider layer (SP), and
at least one server module including said second portion (122b) of smart card middleware comprising said base layer (ICC, IFD, IFD Handler) and said intermediate layer (RM), wherein said at least one client module and said at least one server module communicate with each other over a network (N) via respective stub modules (RS; RM).

14. The method of claim 13, characterized in that it includes the step of said stub modules (RS; RM) hiding the details related to communication over said network (N), whereby said at least one client module interfaces in a substantially identical manner with the base and intermediate layers in both said at least one client module and said at least one server module.

15. The method of claim 14, characterized in that it includes the step of providing a resource manager layer in said at least one client module in the form of a resource manager wrapper.

16. The method of claim 13, characterized in that it includes the step of providing communication between said at least one server module and said at least one client module in the form of an RPC protocol.

17. The method of claim 1, characterized in that it includes the step of determining if every single access to said at least one card reader (IFD) and/or said smart card (ICC) is allowed.

18. The method of claim 17, characterized in that said step of determining is based on at least one of:
a first set of rules for explicitly allowing the usage of said at least one card reader (IFD) and/or said smart card (ICC);
a second set of rules for explicitly denying said usage; and
a default access rule to be applied whenever an access does not match either of the said first and second sets of rules.

19. A system for providing at least one application with access to at least one smart card (SC), the system including:
at least one card reader device (10) for receiving said smart card, and
at least one computer (12) for running said at least one application (121), characterized in that the system further includes:
a first portion (122a) of smart card middleware for running on said at least one computer (12),
a processing unit (16), associated with said card reader device (10), for running a second portion (122b) of smart card middleware,
wherein said first (122a) and second (122b) portion of smart card middleware are adapted to communicate by means of a network (N2), thereby permitting access to said at least one smart card (10) by said at least one application (121).

20. A system according to claim 19, further comprising a network (N2) ensuring communication between said first (122a) and second (122b) portion of smart card middleware.

21. The system of claim 19 or 20, for providing said at least one application with access to one of a plurality of a smart card types, characterized in that it includes, incorporated with said first portion (122a) of smart card middleware, information items concerning said plurality of types of smart cards.

22. The system of claim 19 or 20, characterized in that it includes, associated with said processing unit (16), information items specific to managing said card reader device (10).

23. The system of claim 19 or 20, characterized in that said network (N2) is a local network.

24. The system of claim 19 or 20, characterized in that said network (N2) is a geographic network such as the Internet.

25. The system of claim 19 or 20, characterized in that said at least one computer is configured for running concurrently at least one pair of said applications (121) and providing said at least one pair of applications (121) with access to said at least one smart card (10) via said card reader device (10) interfaced with respective first (122a) and second (122b) portions of smart card middleware via said network (N2) and said processing unit (16).

26. The system of claim 25, characterized in that it includes at least one pair of different computers for running concurrently respective applications (121).

27. The system of claim 19 or 20, characterized in that it includes:
at least one pair of computers (12) each running at least one respective application (121),
at least one card reader device (10) having associated said processing unit (16), and
said network (N2) connecting said at least one pair of computers (12) to said at least one card reader device (10).

28. The system of claim 19 or 20, characterized in that it includes:
at least one pair of card reader devices (10) having associated respective processing units (10), and
said at least one pair of card reader devices (10) connected to said network (N2) whereby said at least one application (121) is adapted to access respective smart cards (10) received in any of said at least one pair of card reader devices (10) in a substantially identical manner.

29. The system of claim 28, characterized in that said card reader devices of said at least one pair of card reader devices (10) are arranged at different geographic locations.

30. The system of claim 19 or 20, characterized in that it includes, incorporated to said first portion (122a) of smart card middleware, information items concerning available system resources, whereby said at least one application is adapted to identify said system resources via said first portion (122a) of smart card middleware.

31. The system of claim 19 or 20, characterized in that it includes a system architecture including:
a base layer including said at least one card reader device (ICC; IFD) as well as a respective interface handler (IFD Handler) formatting the capabilities of said card reader device in a defined application programming interface (IPI),
an intermediate layer (RM) providing a resource manager (RM) capability for managing resources of said at least smart card interfacing with said first level, and
a service provider layer (SP) for encapsulating the functionality of said at least one smart card (10) and exposing a high level interface to said at least one application (121).

32. The system of claim 31, characterized in that said architecture includes:
at least one client module including said first portion (122a) of smart card middleware comprising said base layer (ICC, IFD, IFD Handler) and said intermediate layer (RM), and including said service provider layer (SP), and
at least one server module including said second portion (122b) of smart card middleware comprising said base layer (ICC, IFD, IFD Handler) and said intermediate layer (RM), wherein said at least one client module and said at least one server module communicate with each other over a network (N) via respective stub modules (RS; RM).

33. The system of claim 32, characterized in that it includes said stub modules (RS; RM) configured for hiding the details related to communication over said network (N), whereby said at least one client module interfaces in a substantially identical manner with the base and intermediate layers in both said at least one client module and said at least one server module.

34. The system of claim 33, characterized in that it includes a resource manager layer in said at least one client module in the form of a resource manager wrapper.

35. The system of claim 31, characterized in that it includes a communication facility between said at least one server module and said at least one client module in the form of an RPC protocol.

36. The system of claim 19 or 20, characterized in that it includes an access module (AA) configured for determining if every single access to said at least one card reader (IFD) and/or said smart card (ICC) is allowed.

37. The system of claim 36, characterized in that said access module (AA) is configured for applying at least one of:
a first set of rules for explicitly allowing the usage of said at least one card reader (IFD) and/or said smart card (ICC);
a second set of rules for explicitly denying said usage; and
a default access rule to be applied whenever an access does not match either of the said first and second sets of rules.

38. A computer program product loadable in the memory of at least one computer and including software code portions for performing the method of any of claims 1 to 18.
